(19) United States
(12) Patent Application Publication
(10) Pub. No.: US 2005/0055303 A1
(43) Pub. Date: Mar. 10, 2005

(54) Method for incentivizing customers to confirm advance purchase orders

(75) Inventor: Michael Routtenberg, Surrey (CA)

Correspondence Address: Steven H. Arterberry, Esq.;DORSEY & WHITNEY LLP, Suite 3400, 1420 Fifth Avenue, Seattle, WA, 98101, US

(73) Assignee: General Hydrogen Corp.

(21) Appl. No.: 10/658,524

(22) Filed: Sep. 8, 2003

(51) Int. Cl. G06F 17/60

(52) U.S. Cl. 705/37

(57) ABSTRACT

A method of obtaining an advance irrevocable purchase order from a buyer for future delivery of a manufacturer's product. A buyer is issued a right to obtain a selected number of warrants of a manufacturer when the buyer places a revocable purchase order before the start of a vesting period for a selected number of products or services, the number of obtainable warrants being related to the size or value of the purchase order. A strike price is set for the warrants before the start of the vesting period. A selected number of warrants are granted to the buyer at the strike price when the buyer irrevocably confirms the purchase of at least part of the purchase order before the end of the vesting period, the number of granted warrants being related to the size or value of the purchase order that is irrevocably confirmed and being up to the number of remaining obtainable warrants. An incentive to confirm irrevocable orders in advance is implemented by reducing the number of obtainable warrants as time elapses during the vesting period, creating a realizable gain that induces a feedback process between size and date of order confirmation and stock price of the manufacturer.

### FIELD OF THE INVENTION

This invention relates generally to a method for incentivizing a customer to confirm an advance purchase order from a manufacturer.

### BACKGROUND OF THE INVENTION

There are industries and markets where the product development is extended and uncertain, with future success depending on critical cost-performance breakthroughs in technological advances. The fuel cell and Hydrogen economy is such an industry, where the economic equation for replacing existing power supplies requires a future development in lowering the cost-performance of the fuel cell stack and significant investment to commercialize to provide products to a large multi-billion dollar market opportunity. A challenge in these industries arises in how to create and retain market traction and commitment without being able to provide the product until a later date after product development and commercialization. This problem may be stated as how to create adequate incentive for customers to pre-order and commit and remain with one supplier for a product that will not be in commercial mass production until a future date. There are significant challenges including opportunity cost, product development risk, volume purchasing from suppliers risk and financial risk not adequately overcome by existing methods.

### SUMMARY OF THE INVENTION

It is an object of the invention to provide a rapid commercialization strategy for a manufacturer. In particular, it is an object of the invention to provide an incentive to buyers of the manufacturer's products or services to irrevocably confirm their purchase orders in advance of delivery of the products or services.

Therefore, according to one aspect of the invention, there is provided a method of obtaining an advance irrevocable purchase order from a buyer for a product or service of a manufacturer, comprising:
a. issuing to a buyer a right to obtain a selected number of warrants of a manufacturer when the buyer places a revocable purchase order before the start of a vesting period for a selected number of products or services, the number of obtainable warrants being related to the size or value of the purchase order;
b. setting a strike price for the warrants before the start of the vesting period;
c. reducing the number of obtainable warrants as time elapses during the vesting period; and
d. granting a selected number of warrants to the buyer at the strike price when the buyer irrevocably confirms the purchase of at least part of the purchase order before the end of the vesting period, the number of granted warrants being related to the size or value of the purchase order that is irrevocably confirmed and being up to the number of remaining obtainable warrants.

The revocable purchase order can be placed before the manufacturer's initial public offering date. The vesting period can begin at the date the buyer places the revocable purchase order, and can end around the time of the planned delivery date of the product or service. The method can further comprise publicly disclosing the revocable and irrevocable purchase orders after the initial public offering date in order to promote the manufacturer and increase the manufacturer's share price, thereby motivating the buyer to irrevocably confirm its remaining unconfirmed purchase order before the end of the vesting period, as an increase in share price results in an increase in the capital gain resulting from exercising the warrants. The increase in capital gain offsets or eliminate the opportunity cost perceived by the buyer in placing an advance purchase order.

The number of obtainable warrants can be reduced to zero at the end of the vesting period. Also, the number of obtainable warrants can be reduced in stages over the vesting period. This motivates the buyer to irrevocably confirm the buyer's purchase order earlier rather than later. However, the revocable purchase orders can be revoked without penalty or cost to the buyer.

It is an object of the invention to avoid pricing pressure from competitors at a later date. Therefore, the number of obtainable warrants can be reduced when the buyer enters into a commercial relationship with a competitor to the manufacturer. This dissuades the buyer from revoking the buyer's purchase order with the manufacturer.

The warrant strike price can be the share price of the manufacturer at the warrant strike date.

An initial purchase order agreement can be executed with the buyer at the time the buyer places the revocable purchase order. The agreement defines the warrant strike price, a planned product delivery date, the vesting period, and the rate of reduction in obtainable warrants during the vesting period.

A deposit can be received from the buyer at the date the buyer irrevocably confirms at least part of its purchase order. This provides capital to fund the manufacturer's commercialization efforts. Furthermore, the selected number of warrants can be issued to the buyer only when the buyer places a revocable purchase order above a minimum value.

### BRIEF DESCRIPTION OF DRAWINGS

FIG. 1 is a timeline chart illustrating the steps in a business method according to one embodiment of the invention.

FIG. 2 is a chart of a customer order book used in the method illustrated in FIG. 1, wherein two customers i and j are shown with respective breakdowns of monetary value of all purchase orders.

FIG. 3 is a representation of a warrant allocation function used in the method illustrated in FIG. 1, wherein the relationships between demand, unit price and capital gain potential are shown.

FIG. 4 is a process flow chart of the warrant allocation process for a customer i.

FIG. 5 is a process flow chart showing the warrant process for a jth customer.

FIG. 6 is a process flow chart of a relationship between a public company's stock reporting activities and a customer's purchase decisions demonstrating a positive feedback phenomenon.

FIG. 7 is a process flow chart of a simplified embodiment of method steps by the manufacturer.

FIG. 8 is a diagram of a net cost analysis process for a customer j before a customer i commits showing a cost savings S1

FIG. 9 is a diagram of a net cost analysis process for a customer j after feedback that a customer i commits showing a cost savings S2 greater than S1

### DETAILED DESCRIPTION OF EMBODIMENTS OF THE INVENTION

According to one embodiment of the invention, a business process is provided which is applicable to companies whose stock is privately held and whose intention is to go public, and in a special case, companies already having publicly traded stock. Customers of such companies may enter into a purchase order agreement and be incentivized to confirm full or partial portions of an order for future delivery of a product or service, in order to generate revenue for the company and increase the underlying value of the company. Such an incentive may be a growth incentive, such as a warrant issued at the inception of the purchase order agreement, with nth order of reverse vesting periods typically following IPO or liquidity of the company's stock.

The participants in the business process include a buyer and a manufacturer. For the purposes of this description, a buyer means a potential customer or an existing customer, who has or expects a business demand for the manufacturer's product. A manufacturer is defined in this description as the company who produces the product being sold or a provider corporation in the case of services. The manufacturer entity is also referred to also as the issuer or issuing company in this description.

To reduce risk to the buyer, the buyer is invited by the manufacturer to place a purchase order for the manufacturer's product or service in advance of the product or service's planned delivery date, wherein the purchase order is fully revocable without penalty or cost to the buyer before the planned delivery date.

To provide incentive to the buyer to irrevocably confirm the buyer's purchase order, the manufacturer provides an incentive in the form of a right to obtain a selected number of warrants (“obtainable warrants”) of the manufacturer at a set strike price, and that can be exercised for shares in the manufacturer after the manufacturer goes public, provided that the buyer irrevocably confirms its purchase order within a predefined vesting period. The vesting period typically starts at the date the revocable order is placed, and typically ends in the planned product delivery date range.

Customers have a natural reluctance to make an advance irrevocable purchase commitment. The driver for this reluctance is the real or perceived opportunity cost associated with such advance commitment. Technology advances and price decreases from mass production mean that a given expenditure on technology-based products will likely deliver more value in the future than it will today. The loss in value associated with committing to purchase products (that can't be delivered for several years) today, rather than waiting to purchase those same products on the open market in several years, defines the opportunity cost unique to each customer. Under such circumstances, the only way to extract substantial early purchase commitments from customers is to provide them with some tangible value, which offsets the opportunity cost. A purchase commitment can occur when the customer perceives the net cost of making a purchase commitment today as being lower than the net cost of making that purchase commitment in the future. For this to happen, the value of the offsetting tangible asset must exceed the perceived opportunity cost.

Since it is difficult to quantify opportunity costs, and the perception of such costs can vary significantly between customers and over time, it is not clear what the value of the offsetting tangible asset must be. However, if the offsetting tangible asset is something which steadily and rapidly grows in value over time, it will eventually overtake the perceived opportunity cost by an amount which effectively reduces the net purchase price of the products to a point where the customer perceives an early purchase commitment as having a higher probability of a lower net price than a later purchase commitment.

In this business process, the offsetting tangible assets take the form of warrants, which are allotted to the customer upon receipt of an initial revocable purchase order(s). Since the initial purchase order is revocable without monetary cost or penalty to the customer, it creates an opportunity for the customer, without obligation or risk. Opportunity without risk provides an appealing value proposition to the customer, and hence, should be saleable. The manufacturer determines the strike price of the obtainable warrants, at the time of issuing the purchase agreement. For the case of issuing a revocable P.O. prior to the Initial Public Offering (IPO) the strike price may correlate to share value at the time of issuing the purchase order, or alternatively share value at or just prior to the IPO.

For the alternate process of issuing a revocable P.O. after the IPO, the strike price would be the current share price of the manufacturer. The method is optimized when the strike price is maintained to maximize realizable gain for the customer, hence issuing the revocable P.O. prior to IPO is preferred.

To motivate the buyer to confirm the buyers purchase order sooner rather than later, the value of the incentive decays with time: the number of obtainable warrants decreases over a reverse vesting period typically defined as the period between the manufacturer's initial public offering date and the end of the vesting period.

Warrants vest with the buyer when the buyer irrevocably confirms at least part of its order during the vesting period; the number of warrants vesting is related to the size of the purchase order that is confirmed. When the buyer confirms all of its purchase order before the start of the reverse vesting period, all of the obtainable warrants vest with the buyer. However, should the buyer confirm the buyers purchase order during the reverse vesting period, the maximum number of vesting warrants cannot exceed the number of remaining obtainable warrants. Therefore, the buyer is motivated to confirm the buyers order as soon as possible, and preferably before the start of the reverse vesting period.

The customer has ownership only of those warrants that have vested. Vested warrants have an expiry date, which is at some specified date subsequent to the end of the vesting period. Vested warrants offer capital gains potential because they offer both intrinsic value and time value. The intrinsic value equals the difference between the share price and the strike price, since warrants grant the holder the right to purchase the manufacturer's shares at a specified strike price which is fixed and independent of the manufacturer's current share price. The time value is established through applying such standard calculations as Black-Scholes. Warrants are a preferred security as they can be issued from shares allocated in the issuing companies treasury, and typically have extended expiry dates. The Black-Scholes model, developed by Fischer Black and Myron Scholes in the early 1970s, calculates the present value of a stock option as of its grant date, based on specific information about the terms of the option and assumptions about future stock price performance. The value calculated by Black-Scholes is an estimate of the price someone would pay for the option in the market today. The method assumes that the underlying stock behaves in a way that future prices can be modeled by a probability distribution.

A purchase order agreement between the buyer and manufacturer is executed when the revocable purchase order is placed. The purchase order agreement is an offering for a pre-defined product to be delivered at a future date and meeting specifications set out in the agreement. The revocable purchase order agreements may be executed before the IPO of the manufacturer, or in a special case, for a period immediately after the IPO under disclosure restrictions, with appropriate allocation and vesting. This embodiment describes a pre-IPO execution of revocable purchase orders. At and following IPO of the manufacturer, public disclosure of material change of the manufacturer is publicly reported, including the value of revocable and irrevocably purchase orders, which may not be on the balance sheet but will contribute to underlying business value. As an example of a specific application of this method, a market for forklift power supplies is discussed, specifically fuel cell power packs for forklift vehicles to replace existing battery powered packs for which the capital and operating costs are well characterized.

For this description, a revocable purchase order is defined as an agreement that can be deemed revoked without penalty, cost or obligation to the customer, in the event the customer has not voluntarily removed subject conditions associated with risks and reliability of the product and standard business conditions of performance and solvency of the manufacturer. The revocable purchase order becomes irrevocably binding when, prior to the end of the vesting period, the customer agrees in writing it is completely satisfied with certain subject conditions described in the revocable purchase order. Subject conditions may include but are not restricted to acceptable warranty underwriters, customer site testing, and validation of proposed value proposition of the product or service.

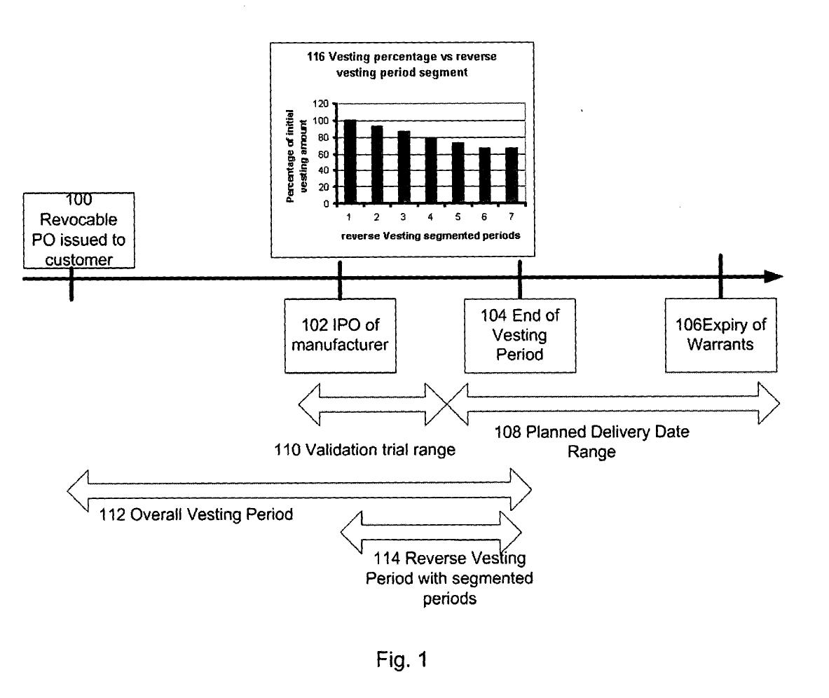

Referring to FIG. 1, the dates of certain steps carried out in business method is shown in relation to certain milestone events of the manufacturer company. At method starts at date 100 when the buyer places a revocable purchase order and executes a purchase order agreement. The manufacturer makes its initial public offering at date 102, which starts the reverse vesting period as set out in the agreement. The vesting period ends at date 104, as predefined in the agreement. The vesting period 112 is shown as the period between dates 100 and 104; the buyer will be granted warrants if it confirms its purchase order during the vesting period 112. The reverse vesting period 114 is shown as the period between dates 102 and 104. The warrants expire at a date 106 as predefined in the agreement; the exercise period is thus defined as the period between the vesting date of the warrants and the warrant expiration date 106. The graph 116 illustrates the decay of obtainable warrants during the reverse vesting period as a percentage of the initial number of obtainable warrants. One of the conditions of making the P.O. irrevocable is a product validation trial, which may occur during the validation trial date range 110, which may start before the IPO date 102. The planned delivery of product may occur within a planned delivery date range 108, and may start before the end of vesting period end date 104 and depending on the customer delivery schedule agreed to, may extend beyond the warrant expiry date 106.

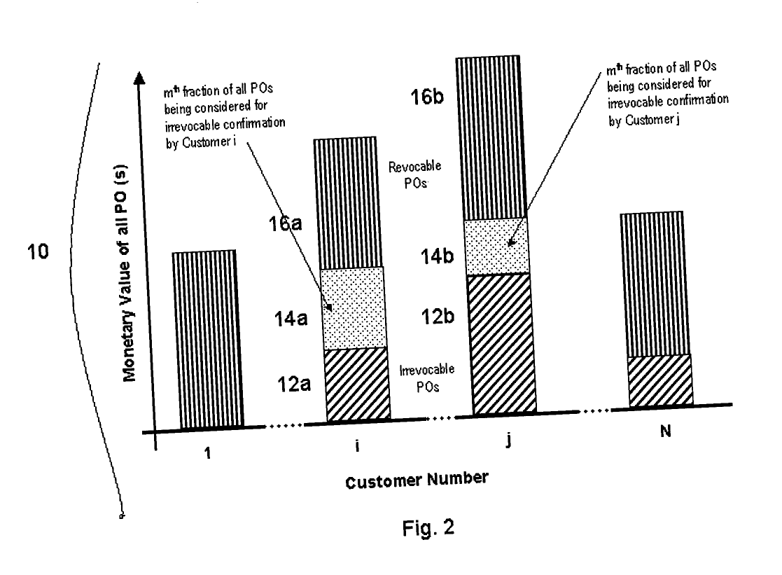

Referring to FIG. 2, a graphical breakdown of a manufacturer's customer order book 10 is represented for n customers that have placed purchase orders. The monetary value of all of a single customer's purchase orders (or portions) are shown on the Y-axis with a breakdown, for customer I and customer j. The terms purchase order and purchase agreement and P.O. are used interchangeably with the same meaning. For customer I, the P.O.'s are split into irrevocable orders 12a representing confirmed orders on the bottom, next an Mth fraction being considered for irrevocable confirmation 14a (and vesting), followed by the remaining pool of revocable P.O.'s 16a on top. Customer j has different values for the 3 types of P.O.'s corresponding to 12b, 14b and 16b respectively. The entire P.O. of customer 1 is revocable, indicating no, it has not yet confirmed any of its purchase order. Note that the process of the invention permits fractions of the dollar amount of P.O.'s (or portions) to be confirmed irrespective of number of units of products.

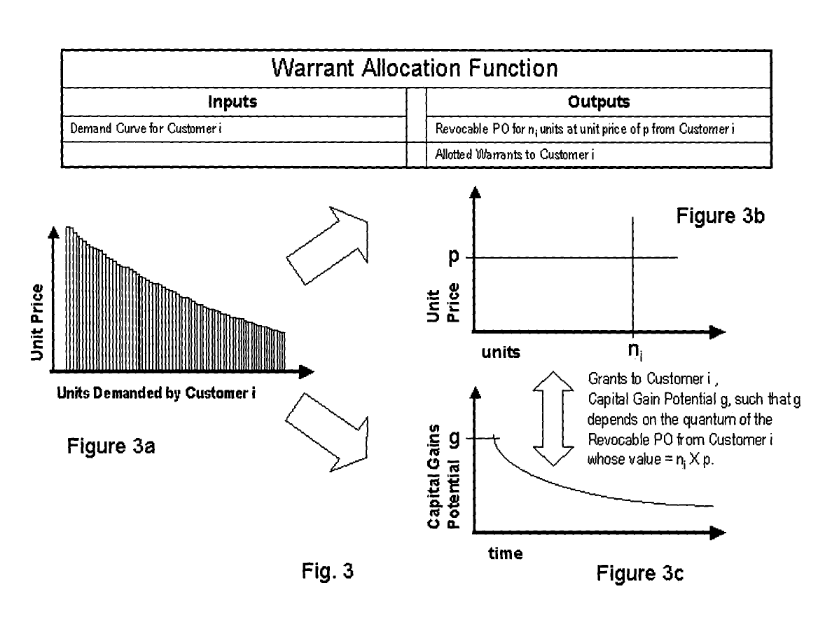

FIG. 3 shows a warrant allocation function that calculates the number of obtainable warrants to be issued to a buyer, and the capital gains potential of the obtainable warrants. The unit price of the ordered product is determined from the graph in FIG. 3(a), which shows that the per unit price decreases with the number of units ordered. With the unit price, the total value of the purchase order can be calculated (unit price*number of products ordered) as shown in FIG. 3(b). With the purchase order value, the number of obtainable warrants are calculated and allotted to customer i based on the value of the revocable P.O., (The terms “allotted” or “allocated warrants” are also used to describe obtainable warrants).

The capital gains potential granted to the customer through the warrants is dependent on the quantum or portion of the revocable P.O. whose total value of portion=Ni×Pn, the strike price and share price, and varies with time as shown in FIG. 3c due to the vesting terms of the warrants i.e. potential=share price−strike price*number of obtainable warrants. The decrease in capital gains potential with time, indicates a time incentive for the customer to decide what amount of the potential should be realized by when, based on the customers analysis of lost value associated with the decision. As described, other market and customer variables provide feed back into the customer's determination of cost savings by confirming an order by a specific time. The outcome of the process described in FIGS. 3a-c is:
a revocable P.O. for Ni units at a price of Pn from customer i;
obtainable warrants to customer I at a determined strike price value.

This is a purchase order maximizing process, such that the number of obtainable warrants allotted to the customer is established by the value of a warrant allocation process and the number of warrants allocated to a customer increases as the magnitude of the initial revocable purchase order(s) increases.

Additional restrictions may be applied to the revocable purchase order to maintain quality of customers, such as the manufacturer requiring the customer to pay a deposit, for example, 10%, when the purchase order is irrevocably confirmed, with the balance due on delivery of the product. The incentive rights may be further restricted to purchase orders greater than a threshold set by the manufacturer, as further incentive to place large orders. The order threshold is desired to be significant, to enable cumulative large contributions aimed at target volumes required by the manufacturer to produce lower cost systems, an example is a $25 million order threshold to receive the incentive rights.

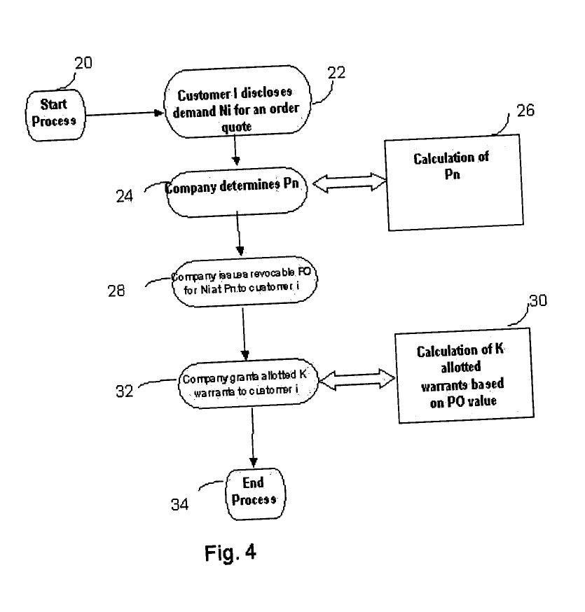

The function described in FIG. 3 results in a process for allotment of obtainable warrants, as shown in FIG. 4. The process is started in step 20, and a customer discloses demand for a number of units in step 22. Note for the purpose of this example, the demand number is fixed for the purpose of setting a fixed price, however it will be evident to a skilled person that the demand can be varied over time or over multiple products, and still be covered by the scope of the invention. Based on an ith customer wanting number Ni units, the manufacturer determines the Pn price per unit in step 24 by performing a calculating step 26. The estimation of forecast price per unit volume is common in industry and depends on multiple variables specific to a future product including demand, expected innovation, market conditions, materials cost forecast, yield and reliability, and development time etc. Based on information from the above steps, the manufacturer in step 28, executes a revocable P.O. with the ith customer for Ni units at Pn unit price. Concurrently in steps 30 and 32, K number of warrants are allotted as a percentage of the value of the P.O. as defined by Ni×Pn, for example 10%. In one embodiment the expected future value of the warrants is equal to the P.O. value virtually eliminating risk of financial loss by the buyer. The process is terminated at step 34. Each buyer who participates goes through this process and receive a corresponding allotment, until the allocation is used up.

The warrants available to an individual customer, (considered to be iteration j for this example), are determined by a warrant vesting and reverse vesting process. The warrant vesting process causes warrants to vest to the customer when some fraction of the Customer's Revocable P.O.(s) is confirmed. The larger the fraction of the P.O. irrevocably confirmed on any given date within the term of the vesting period, the greater the number of warrants that vest. Over the reverse vesting period (e.g. between the IPO date and the end of the vesting period), there may be a plurality of segmented periods, such as quarter years, and the number of obtainable warrants are reduced per segmented period to provide the time-sensitive incentive, with a corresponding “rate of reduction” as shown in table 1. The Reverse Vesting Process Warrants reverse vests, or returns to the manufacturer's treasury, some fraction of warrants that have not yet vested. As more time elapses, more warrants reverse vest. All remaining warrants reverse vest at the end of the term of the P.O., and the process terminates.

TABLE 1
Example of vesting for reverse vesting segmented periods post-
IPO

| | Vesting per | |
|---|---|---|
| | $1 M | |
| Quarter | confirmed | % vested |
| Q1 | 15,000 | 100 |
| Q2 | 14,000 | 93 |
| Q3 | 13,000 | 87 |
| Q4 | 12,000 | 80 |
| Q5 | 11,000 | 73 |
| Q6 | 10,000 | 67 |
| Q7 | 10,000 | 67 |

Purchase agreement example terms are 15,000 warrants for every $1M in purchase agreements for confirmations before IPO and post-IPO with a schedule of reverse vesting as shown in the table, the warrants expire in 5 years (creating time value).

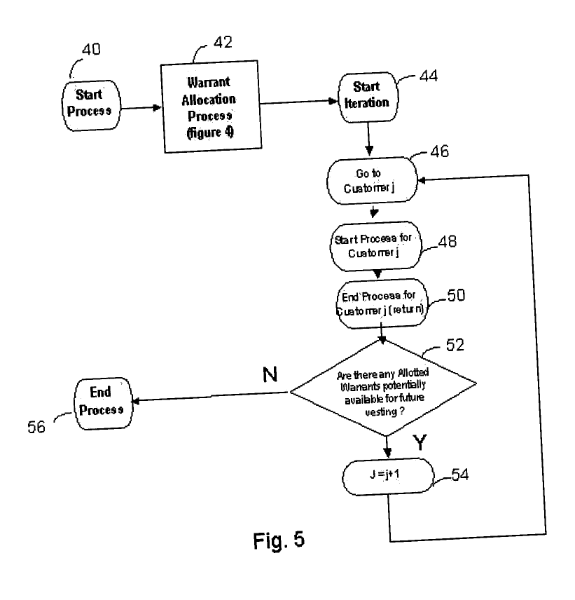

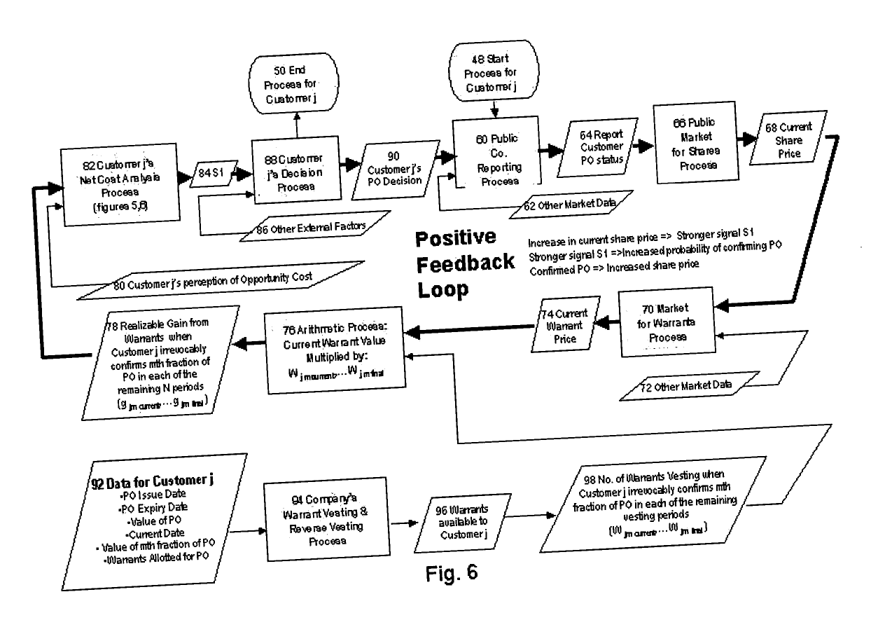

The process in FIG. 5 shows the start to finish process of warrant utilization for a jth customer iteration following allocation of obtainable warrants and IPO of the manufacturer. The warrant allocation process from FIG. 4 is shown as step 40, then the iterative process starts 44, beginning with a customer j in step 48 and starting a customer jth process (shown in FIG. 6) where the obtainable warrants available to the customer j are calculated in step 96 of FIG. 6, and customer j makes a decision to confirm an mth portion of the P.O. Based on the confirmation decision, the number of vested and reverse vested warrants is known. The method returns to step 50 at the end process for this iteration for customer j, and the information on warrant utilization is input to a decision step 52 to determine if there are available warrants for future vesting. If there are, the next customer number is advanced in step 54. This process can be repeated many times for each customer interaction. When all allotted warrants for all customers are utilized or reverse vested, the warrant utilization process ends in step 56.

The feedback mechanism between realizable gain to the customer and stock value requires various calculations and inputs to the participants as shown in FIG. 6. The principle of the methodology will be described and then the steps in the figure.

As the manufacturer's stock price fluctuates in a public market, so will the price of its warrants. At some point, a rising intrinsic value of obtainable warrants will, for some customers, create the perception that an early purchase commitment has a higher probability of a lower net price than a future purchase commitment. Under such circumstances, some of these customers will make an irrevocable purchase commitment for some selected fraction of their total purchase order. The time dependent reverse vesting of the warrants means that the net purchase price is lower; the earlier the commitment is made. This provides customers an incentive to act sooner rather than later.

Irrevocable confirmation of significant customer orders ensures future revenue for the manufacturer, and helps to establish market leadership and improves economies of scale—all of which implies future growth in revenue and profitability. Implied future growth in revenue and profitability increases the manufacturer's underlying business value. The increase in the underlying business value has the effect of increasing the value of the manufacturer's stock price (since stock price correlates to underlying business value). An increase in the manufacturer's stock price increases the intrinsic value of the manufacturer's warrants allowing a positive feedback process.

Referring to FIG. 6, the process is considered for the case of the manufacturer company having gone public and a customer who has not confirmed all obtainable warrants prior to the current segmented period. For such a customer j, the feedback process can consider to start at step 60, where the manufacturer company reports standard material financial information relating to market capitalization, shares outstanding, and warrants status on a regular reporting period, for example quarterly. Other external market data affecting the companies business, such as the price of hydrogen may be input from step 62. The reporting process also includes step 64, reporting the complete customer order book showing status of confirmed and unconfirmed order value, requiring publicly disclosing the manufacturer's orders. This may be reported on the same time period as step 60 or at more frequent intervals through publicly accessible information. A public market for the shares responds in step 66 to the information from the previous steps as well as market demand, and determines a current share price in step 68.

The share price is input to step 70, a market for the manufacturer's warrants. Again, other market data 72 may be an input to the warrant market. The warrant market 70 determines a current warrant price in step 74. The warrant price includes an intrinsic value and a time value. For example, a warrant with strike price $10 could have current net present value NPV ($54) and a time value ($30) both of which can be calculated from standard formulas such as (Black-Scholes) and providing appreciable gain to the customer. In this embodiment, the expiry date of the warrant is substantially after the end of the vesting period, which avoids negative feedback by eliminating time pressure to exercise the vested warrant.

A series of steps (92, 94, 96, 98) represent determination of the number of warrants vesting for customer j for a mth order portion, for current and remaining reverse vesting segmented periods, as a necessary input to customer j warrant valuation. Data required for the manufacturer company's vesting process in step 94, may include but is not restricted to the following of step 92;
I. Current date
II. PO issue date
III. PO expiry date
IV. Value of the P.O.
V. Value of the mth fraction of the P.O.
VI. Warrants allotted for the P.O.

Typically, only value of the mth fraction of the PO (V), warrants allotted (VI), and the current date (I—to determine reverse vesting segmented period) affects the determination of number of warrants vesting. The value of the PO must also be above a minimum threshold to receive any warrants.

The larger the mth fraction of the P.O. irrevocably confirmed on any given date within the reverse vesting segmented period, the greater the number of warrants that vest. For confirmed orders after the IPO, the later the current date, the larger the amount of reverse vesting penalty per segmented period. The vesting and reverse vesting conditions described, are provided to the customer at issuance of the purchase agreement, to allow the customer to make financial calculations independently. In one embodiment, the earlier that P.O. issue date is, the greater the allocation of obtainable warrants value, either by increased percentage K of allotment number or in a reduction of reverse vesting.

The next step 96 indicates the warrants available to customer j. Typically this can be calculated by customer j using the conditions in the purchase agreement, or provided by the issuer to the customer j upon request. The customer j planning to make a mth fraction of a P.O. confirmation in each of the remaining periods, can calculate in step 98 the number of warrants vesting due to the confirmations. The inputs from steps 74 and 98 are provided to step 76, which multiplies the current warrant value 74 to each current and remaining warrant and in step 78, sums the total to produce a realizable gain from each segmented period based on irrevocably confirming the mth fraction of the P.O. in each of the remaining N segmented periods. The net realizable gain is the sum of each realizable gain in the reverse vesting segmented periods for the planned confirmations and is input to step 82 for net cost analysis.

As described earlier, the loss in value associated with committing to purchase products (that can't be delivered for several years) today, rather than waiting to purchase those same products on the open market in several years, defines the opportunity cost. The opportunity cost is derived by each customer, based on their perception of future cost savings from delaying commitment. Step 80 shows customer j's perception of the opportunity cost as input to the customer's net cost analysis in step 82.
Cost Savings S=G(realizable gain for the current period)−Opportunity cost.

Typically, S is positive when the realizable gain offsets the opportunity cost. Since realizable gain decreases with each reverse vesting segmented period. If the stock price stayed constant, S would decrease and become negative in future reverse vesting segmented periods. However, due to the invention methodology, the stock price is coupled to the underlying value represented in the total customer orders and will typically increase as more and larger mth order portions are confirmed through the reverse vesting segmented periods, so S will vary accordingly and not decrease as with time. Step 84 represents the output S of calculation 82 which inputs to a customer decision process 88, along with other external factors 86 such as available cash, trial validation etc.

The customer may decide to either confirm the mth portion of the P.O. or take no action in which case the available warrants for the current segmented period reverse vest to the issuer. When the customer confirms the order, the corresponding available warrants vest and can be exercised or redeemed on a date after the company's IPO date for shares, and issued from the manufacturer corporate treasury. Typically, this will result in no change to fully diluted market capitalization as the allocation of customer warrants was preferably made by the manufacturer pre-IPO, but results in a material change to the trading shares outstanding. The outcome 90 is input back into the public company reporting, updating shares outstanding, reverted warrants and additions to customer order book. Customer j returns to the warrant utilization process in FIG. 5 in step 50. The process is repeated for a Jth+1 customer who will now respond to the updated information from customer j. It is expected that multiple customers will make confirmation decisions at different times or concurrently with each other. Available transaction processing and networking capability already provides near real-time reporting and quotes for existing markets and can similarly be adapted to receive and provide necessary updates based on time of arrival rules for new information from customers and the issuer. Furthermore, all material change reporting in the process is harmonized with appropriate securities regulations governing the markets (such as from the SEC).

The process has described how an increase in share price results in an increased customer cost savings when the corresponding order is confirmed in the current reverse vesting segmented period, which incentivizes customers to confirm orders in this period, which is reported back to increase the underlying business value of the manufacturer, creating a feedback process.
Share price∝S∝Increased Probability of confirming P.O.
Confirmed P.O. value∝share price

The net present value (NPV) of the manufacturer value is proportional to the value of confirmed orders, and should correlate to public stock value after the IPO. This allows for a correlation and feedback between the incentive and early commitment on the part of the customer. The more value the customers order, the more the value of the stock rises.

The process provides low risk and flexibility in that the customer can confirm portions of a purchase order dollar value while waiting for perceived risk or opportunity cost to be reduced, or confirm the entire amount at any time, or confirm no orders with no financial obligation. The use of multiple reverse vesting segmented periods (example 7 quarterly periods) allows for iterative valuation decisions and flexibility by the customer, while iterating through small changes in share value, which are acceptable for public markets and major shareholders. In one embodiment, the segmented periods overlap with prototype product validation, for example, for fuel cell power packs used to power forklift vehicles, where the validation risk and opportunity cost decrease as performance and cost data is verified. Such prototype product validation may be conducted on individual customer sites to prove specific value targets. Following validation, product delivery commences after a period of time set in the revocable purchase order and may also extend over a set completion of delivery period similarly agreed in the purchase agreement. The planned product delivery date as provided in the revocable purchase order, may occur before, at or after the end of the vesting period and is not restricted, although a date range may be agreed with the customer to set unit pricing. Upon delivery and satisfactory performance per the purchase agreement, the customer pays the agreed price per delivery, to the manufacturer.

In another embodiment of the invention, the available incentive value is reduced or eliminated if the customer starts a commercial relationship with a competitor to the manufacturer's product offering. The purchase agreement includes a term detailing elimination or reduction in the customer's rights to obtain warrants upon occurrence of such competitor business. A commercial relationship may include requests for quote, product testing and validation, joint ventures, or disclosure of pricing targets provided by the manufacturer.

Due to the necessity for releasing customer order status following IPO of the manufacturer to provide suitable information, an embodiment of the invention includes clauses in the purchase agreement authorizing permission from the customer for the issuer to disclose order information as a condition to receiving the incentive rights.

The following is an example of application of the business method for sale of a fuel cell power pack for electric forklifts. The example is derived using standard financial valuation formulas such as discounted cash flow, and shows a significant market capitalization of the manufacturer, at relatively low market penetration of confirmed orders.

Financial model Assumptions:
a) Initial purchase orders for $500 million of fuel cell power packs units have been irrevocably committed prior to 2006.
b) Sales volumes and revenues in 2007 and 2008 are based on the delivery of these pre-sold units.
c) Pre-sold units comprise a reasonable 1% of a specific application market of power supply to electric lift trucks and 0.3% of the total application market for the fuel cell system power pack supply.

d) Valuation of the manufacturer is based on 15×EBITDA (earnings before interest, taxes, depreciation etc) and 15% discount rate, and a 50% ownership of the joint venture.

TABLE 2
Valuation of shares and warrants based on method of the
embodiment

| Date of | Manu- | | | | | |
|---|---|---|---|---|---|---|
| irrevocable | facturer | | Warrant | Warrant | Warrant | Warrant |
| Confirmation | Market Cap | Share | Strike | Intrinsic | Time | Total |
| Of P.O. | ($M) | Price | Price | Value | value | value |
| Q2 2005 | $1,866 | $54 | $10 | $44 | $18 | $62 |
| Q4 2006 | $2,336 | $67 | $10 | $57 | $13 | $70 |

Therefore as observed in Table 2, the result of the embodiment method is that the future value of the manufacturer results in a significant market capitalization due to the underlying business value of the confirmed orders, and the customer value of the warrants demonstrates a larger “in the money” gain for the earlier Q2 2005 confirmation, than for the Q4 2006 confirmation.

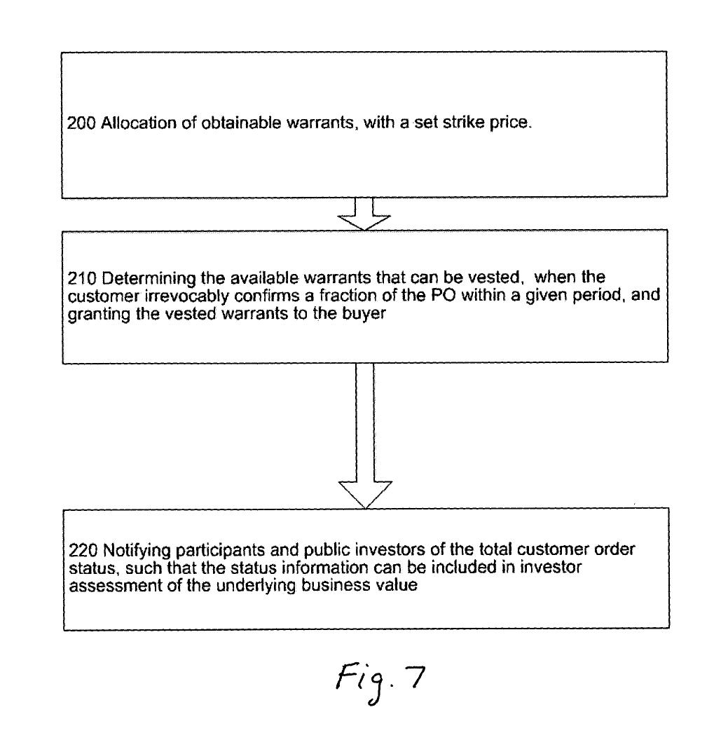

Referring to FIG. 7, a manufacturer can motivate buyers to confirm their unconfirmed purchase orders by regularly publicly reporting the manufacturer's existing purchase orders, which is expected to increase the value of the manufacturer's stock. The resulting increase in stock price will motivate the buyers to confirm more of their unconfirmed purchase orders in order to vest their warrants, which can then be exercised at the strike price for shares which are then sold for profit (assuming of course that the strike price is lower than the stock price at the exercise date). The public reporting of these confirmations is then expected to further increase the value of the manufacturers stock thereby motivating more purchase order confirmations, resulting in a “positive feedback phenomenon”. The process shown in FIG. 7 is again for the conditions of the anufacturer company having gone public and a customer who has not confirmed all obtainable warrants prior to the current segmented period.

In step 200, rights to obtain warrants are allocated to a customer in exchange for a revocable purchase order for a future product delivery, with time-dependent subject conditions upon irrevocably confirming a portion of the order. The subject conditions include vesting and reverse vesting processes, including anumber of reverse vesting segmented periods, vesting and reverse vesting amounts in each segmented period and expiry date. A strike price for the warrants is set before the start of the vesting period.

The customer warrants available for vesting are determined in step 210, as previously described as a percentage of the fractional PO value. The vested warrants are then granted when the customer confirms the fractional PO value. A key step is described in 220, of notifying participants and public investors of the total customer order status, such that the status information can be included in market assessment of the underlying business value. The manufacturer has control over these 3 steps, which represent the core methodology of the business process in its simplified embodiment described by FIG. 7. The outcome of the steps in FIG. 7, allows a positive feedback mechanism between total customer confirmed orders and individual customer realizable gain from available warrants, increasing the incentive for customers to confirm orders and investors to increase perceived valuations of the manufacturer's equity stock.

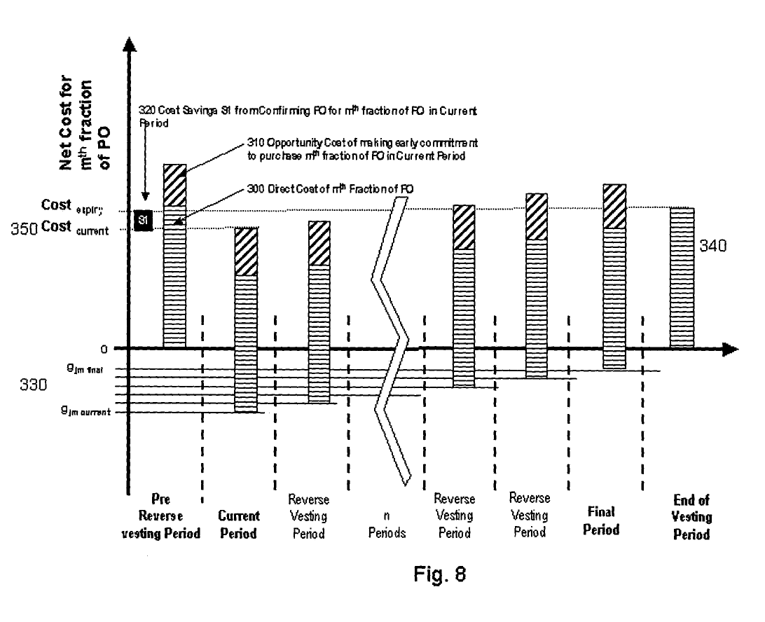

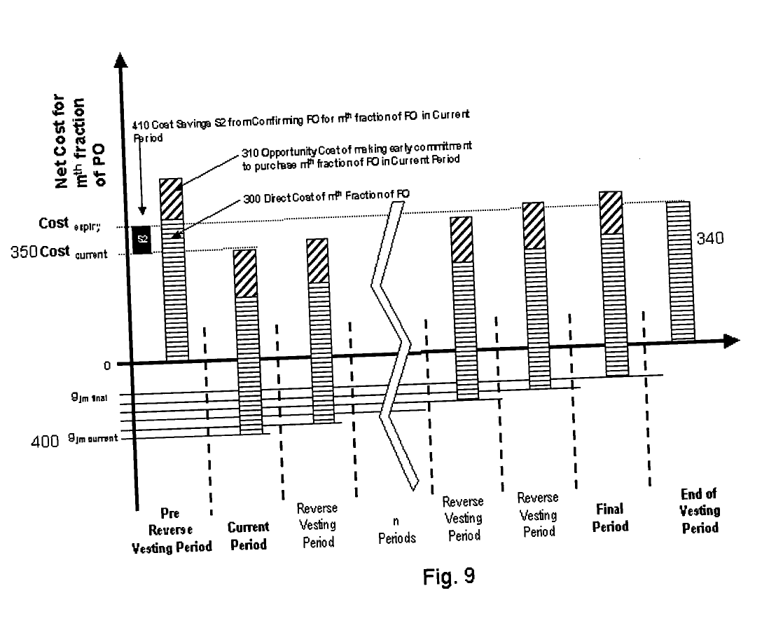

The operation of the business process is illustrated in FIGS. 8 and 9 to show two determinations of cost savings S that demonstrate the positive feedback phenomenon described in FIGS. 6 and 7. The FIGS. 8 and 9 are again for the starting conditions of the manufacturer company having gone public and a customer who has not confirmed all obtainable warrants prior to the current segmented period. A graph of reverse vesting segmented periods versus value is shown. The pre-reverse vesting period represents pre-IPO or public liquidity, in this period any vested warrants cannot be executed per the conditions in the purchase agreement. The current segmented period is shown next in time, followed by n segmented periods of reverse vesting. For the example of Table 1, there are seven reverse vesting segmented periods each a quarter yearlong. At the end of the final segmented period, all obtainable warrants are expired. The negative value of the Y-axis represents an offset realizable gain for each segmented period for the mth fraction of the P.O. under consideration by the customer j, and is observed to be greatest in the current segmented period and decreasing to zero at the end of the vesting period.

The bars represent the net cost to the customer for an mth portion of the P.O., and include a cost at expiry (or “end of vesting period”) component 340 and an opportunity cost 310 as previously described. For the purpose of this illustration, the opportunity cost 310 is constant in each segmented period, however it may be variable and decreasing over time.

The cost at expiry 340 represents an upper net cost limit for confirming an order. As can be observed, before the first segmented period (“pre-IPO” in this example) the net cost is greater than the cost at expiry due primarily to the opportunity cost 310. In the current reverse vesting segmented period, the net cost is now offset by a realizable gain g, which reduces the net cost to below the cost at expiry 340, creating a cost savings S1 (320) as per the formula described earlier. With each consecutive segmented period the cost savings S1 decreases and becomes negative as the realizable gain decreases as shown.

FIGS. 8 and 9 represent two different scenarios of the iterative process of FIG. 6. FIG. 8 is at a time prior to another customer I confirming an order.

FIG. 9 is at a time after another customer I has confirmed and reported their confirmation in the public reporting process, and the market has updated to a corresponding increased current share price. Therefore, in FIG. 9, the realizable gain 400 is greater than the realizable gain 330 in FIG. 8 and the cost savings 410 S2 is increased due to the additional offset caused by customer I's order. Similarly, the iterative feedback process of FIG. 6 then continues forward with a j+1 customer following the Jth customer irrevocable order.

As opportunity cost is a perceived value determined by the customer only, it is desirable to find an upper limit on the cost for showing feasibility of the process. The opportunity cost is shown in the equation below, to never exceed the current product purchase price, provided the product technology is useable and not obsolete at the time of delivery, obsolete being defined for this purpose as unable to meet operable customer performance requirements.

The opportunity cost function is given by;
Opportunity cost=Today's Purchase Price×(n−1)/n;
Where n=(Today's purchase price)/(Future purchase Price)

The asymptotic opportunity cost function has a value that can never exceed today's purchase price. Therefore when the value of the capital gain offsets the purchase price entirely, the incentive value and limited maximum risk should be suitable to incentivize the customer to confirm all orders, or remainder of purchase order.

An illustrative example;
Today's purchase price=$10,000;
Future purchase price (5 years)=$1,000 n=10 and;
Opportunity cost=$10,000×(10-1)/10=$9,000.

In this example the customer is passing up $9,000 in value at a delivery date of 5 years in the future, requiring a significant incentive to confirm orders with today's purchase price.

In an alternate embodiment of the invention, options are used in place of warrants and the issuer determines in advance of IPO, to create a pool of available shares for the customer conversion process.

In an alternate embodiment of the invention, a third party acts as the agent of the issuer to provide the issuer functions described herein in exchange for a percentage or fee.

In an alternate embodiment, warrants may be transferred to other customer participants within the same conditions, to create an exchange market, while meeting all SEC regulations concerning such transfer.

As such, a method for incentivizing customers to confirm advance purchase orders is described. In view of the above detailed description and associated drawings, other modifications and variations will now become apparent to those skilled in the art. It should also be apparent that such other modifications and variations might be effected without departing from the spirit and scope of the present invention as set forth in the claims that follow.

1 A method of obtaining an advance irrevocable purchase order from a buyer for a product or service of a manufacturer, comprising:
a. issuing to a buyer a right to obtain a selected number of warrants of a manufacturer when the buyer places a revocable purchase order before the start of a vesting period for a selected number of products or services, the number of obtainable warrants being related to the size or value of the purchase order;
b. setting a strike price for the warrants before the start of the vesting period;
c. reducing the number of obtainable warrants as time elapses during the vesting period; and
d. granting a selected number of warrants to the buyer at the strike price when the buyer irrevocably confirms the purchase of at least part of the purchase order before the end of the vesting period, the number of granted warrants being related to the size or value of the purchase order that is irrevocably confirmed and being up to the number of remaining obtainable warrants.

2. The method of claim 1 wherein the revocable purchase order is placed before the manufacturer's initial public offering date.

3. The method of claim 2 wherein the vesting period begins at the date the buyer places the revocable purchase order and ends at a date after the initial public offering date.

4. The method of claim 3 further comprising after the initial public offering date, publicly disclosing the revocable and irrevocable purchase orders in order to promote the manufacturer and increase the manufacturer's share price, thereby motivating the buyer to irrevocably confirm its remaining unconfirmed purchase order before the end of the vesting period.

5. The method of claim 1 wherein the number of obtainable warrants is reduced to zero at the end of the vesting period.

6. The method of claim 5 wherein the number of obtainable warrants is reduced in stages over the vesting period.

7. The method of claim 1 wherein the warrant strike price is the share price of the manufacturer determined at one of; the warrant allotment date, and the manufacturer IPO date, and at a selected time between the aforementioned dates,

8. The method of claim 1 wherein the number of obtainable warrants is reduced when the buyer enters into a commercial relationship with a competitor to the manufacturer.

9. The method of claim 1 further comprising executing an initial purchase order agreement with the buyer at the time the buyer places the revocable purchase order, the agreement defining the warrant strike price, a planned product delivery date, the vesting period, and the rate of reduction in obtainable warrants during the vesting period.

10. The method of claim 1 further comprising receiving a deposit from the buyer at the date the buyer irrevocably confirms at least part of its purchase order.

11. The method of claim 1 further comprising in step (a) issuing the selected number of warrants to the buyer only when the buyer places a revocable purchase order above a minimum value.

12. The method of claim 1 wherein the revocable purchase orders are revocable without penalty or cost to the buyer.

13. A method of obtaining advance irrevocable purchase orders from buyers for a product or service of a manufacturer, comprising:
a. issuing to each buyer a right to obtain a selected number of warrants of a manufacturer when each buyer places a revocable purchase order before the manufacturer's initial public offering date for a selected number of products or services, the number of obtainable warrants being related to the size or value of the purchase order;
b. setting a strike price for the warrants before the start of a vesting period;
c. reducing the number of obtainable warrants as time elapses during the vesting period; and
d. granting a selected number of warrants to a buyer at the strike price when the buyer irrevocably confirms the purchase of at least part of its purchase order before the end of the vesting period, the number of granted warrants being related to the size or value of the purchase order that is irrevocably confirmed and being up to the number of remaining obtainable warrants; and
e. publicly disclosing the revocable and irrevocable purchase orders after the initial public offering date in order to promote the manufacturer and increase the manufacturer's share price, thereby motivating the buyers to irrevocably confirm their remaining unconfirmed purchase orders before the end of the vesting period.

14. The method of claim 13 wherein the number of obtainable warrants are reduced to zero at the end of the vesting period.

15. The method of claim 14 wherein the number of obtainable warrants are reduced in stages over the vesting period.

16. The method of claim 13 wherein the warrant strike price is the share price of the manufacturer determined at one of; the warrant allotment date, and the manufacturer IPO date, and at a selected time between the aforementioned dates.

17. The method of claim 13 wherein the number of obtainable warrants are reduced when the buyer enters into a commercial relationship with a competitor to the manufacturer.

18. The method of claim 13 further comprising executing an initial purchase order agreement with each buyer at the time the buyer places the revocable purchase order, the agreement defining the warrant strike price, a planned product delivery date, the vesting period, and the rate of reduction in obtainable warrants during the vesting period.

19. The method of claim 13 further comprising in step (a) issuing the selected number of warrants to the buyer only when the buyer places a revocable purchase order above a minimum value.

20. The method of claim 13 wherein the revocable purchase orders are revocable without penalty or cost to the buyer.
